(19) United States
(12) Patent Application Publication
(10) Pub. No.: US 2022/0112364 A1
(43) Pub. Date: Apr. 14, 2022

(54) Pipe Including a Thermoplastic Vulcanizate Composition

(71) Applicant: ExxonMobil Chemical Patents Inc., Baytown, TX (US)

(72) Inventors: Krishnan Anantha Narayana Iyer, Manvel, TX (US); Antonios K. Doufas, Houston, TX (US); Anthony J. Dias, Houston, TX (US)

(21) Appl. No.: 17/435,929

(22) PCT Filed: Mar. 23, 2020
(86) PCT No.: PCT/US2020/024168

§ 371 Date: Sep. 2, 2021

Related U.S. Application Data
(60) Provisional application No. 62/821,859, filed on Mar. 21, 2019.

(51) Int. Cl. C08L 23/12

(52) U.S. Cl. CPC C08L 23/12; F16L 11/04

(57) ABSTRACT

In an embodiment, a thermoplastic vulcanizate (TPV) composition includes a rubber, a thermoplastic polyolefin, and a polyhedral oligomeric silsesquioxane, wherein: a concentration of the rubber is from 10 wt % to 80 wt % based on a combined weight of the rubber and the thermoplastic polyolefin; a concentration of the thermoplastic polyolefin is from 20 wt % to 90 wt % based on the combined weight of the rubber and the thermoplastic polyolefin; and a concentration of the polyhedral oligomeric silsesquioxane is from 0.1 wt % to 20 wt % based on the total weight of the TPV composition. In another embodiment, a process for preparing a dynamically vulcanized thermoplastic vulcanizate composition includes melt processing under shear conditions at least one thermoplastic resin, at least one rubber, at least one curing agent, and at least one polyhedral oligomeric silsesquioxane; and forming a dynamically vulcanized thermoplastic vulcanizate composition. In another embodiment, a pipe is provided.

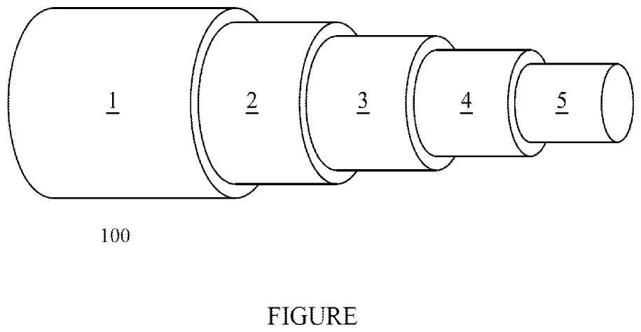

### CROSS-REFERENCE TO RELATED APPLICATIONS

This application claims the priority benefit of Provisional Application No. 62/821,859, filed Mar. 21, 2019, the disclosure of which is incorporated herein by reference.

### FIELD

Embodiments of the present disclosure generally relate to thermoplastic vulcanizate (TPV) compositions that include a polyhedral oligomeric silsesquioxane, and more particularly, to the use of TPV compositions having a polyhedral oligomeric silsesquioxane in a layer of a pipe.

### BACKGROUND

Pipes, e.g., flexible pipes, are used to transport hydrocarbons and other fluids. The flexible pipe structures include layers made of, e.g., polymeric, metallic, and composite layers. Flexible pipes typically include an internal pressure sheath that contacts the fluids being transported in the flexible pipe, an outer sheath that includes a polymer composition, and an annulus region between the inner sheath and outer sheath. The annulus region includes armoring layers (or reinforcing plies) that provide support for the inner pressure sheath and an intermediate sheath that has polymeric layer(s) supported by a reinforcement structure.

While fluid, e.g., hydrocarbons, flows through the flexible pipe, gases (such as CO₂, FES, methane, and water vapor) can diffuse through the inner pressure sheath and into the annulus region between the inner pressure sheath and the outer sheath of the flexible pipe. In the annulus region, the gases accumulate and upon contact with water and/or moisture form acidic conditions that cause corrosion of the typically metallic armoring layers. Such corrosion precipitates failure and breakdown of the flexible pipe and involves a costly shutdown of the fluid transport and replacement of the flexible pipe. In addition, excess buildup of gases and condensate in the annulus space can result in the rupture of the outer sheath when the interior pressure exceeds the pressure outside of the pipe. This risk is particularly high closer to the surface, when the hydrostatic pressure is lower.

To reduce (or eliminate) corrosion of the metallic elements in the flexible pipe, the polymer composition located in the intermediate sheath of the annulus region and/or the outer sheath should be permeable to acidic gases, e.g., CO₂ and H₂S. Moreover, because the polymer composition contacts the gases and external sea conditions, the polymer composition should exhibit various properties, e.g., good resistance to physical and chemical degradation, resistance to hydrolysis, good abrasion resistance, good crack propagation strength, and good fatigue strength.

Therefore, there is a need for a highly permeable polymer composition, and its application in the intermediate sheath of the annulus region and/or the outer sheath of flexible pipes, the composition having a balanced combination of mechanical and physical properties that can reduce (or eliminate) the build-up of acidic gases in the annulus region of flexible pipes.

References for citing in an Information Disclosure Statement (37 CFR 1.97(h)) include: U.S. Pat. Nos. 4,402,346; 6,716,919; 8,256,469; U.S. Patent Publication No. 2007/0119512; U.S. Patent Publication No. 2012/0279575; U.S. Patent Publication No. 2017/0254446; U.S. Patent Application Publication No. 2016/0076675; U.S. Patent Application Publication No. 2016/0186916; International Application No. WO 2011/120525; and Lefebvre, Xavier, et al. “Development of reactive barrier polymers against corrosion for the oil and gas industry: from formulation to qualification through the development of predictive multiphysics modeling,” Oil & Gas Science and Technology-Revue d'IFP Energies Nouvelles 70.2 (2015): 291-303.

### SUMMARY

In an embodiment, a thermoplastic vulcanizate (TPV) composition includes a rubber, a thermoplastic polyolefin, and a polyhedral oligomeric silsesquioxane, wherein: a concentration of the rubber is from 10 wt % to 80 wt % based on a combined weight of the rubber and the thermoplastic polyolefin; a concentration of the thermoplastic polyolefin is from 20 wt % to 90 wt % based on the combined weight of the rubber and the thermoplastic polyolefin; and a concentration of the polyhedral oligomeric silsesquioxane is from 0.1 wt % to 20 wt % based on the total weight of the TPV composition.

In another embodiment, a process for preparing a dynamically vulcanized thermoplastic vulcanizate composition includes melt processing under shear conditions at least one thermoplastic resin, at least one rubber, at least one curing agent, and at least one polyhedral oligomeric silsesquioxane; and forming a dynamically vulcanized thermoplastic vulcanizate composition.

In another embodiment, a pipe includes an outer sheath, the outer sheath including any TPV composition described herein.

In another embodiment, a pipe includes an intermediate sheath, the intermediate sheath including any TPV composition described herein.

In another embodiment, a pipe includes a thermal insulation layer, the thermal insulation layer including any TPV composition described herein.

In another embodiment, a flexible pipe includes an anti-wear layer, the anti-wear layer including any TPV composition described herein.

Other and further embodiments are described below.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, for the disclosure may admit to other equally effective embodiments.

The FIG. shows a side view of a flexible pipe according to some embodiments.

### DETAILED DESCRIPTION

Embodiments of the present disclosure relate to TPV compositions that include one or more polyhedral oligomeric silsesquioxanes, and use of the composition(s) in a layer of a flexible or rigid pipe (e.g., an outer sheath and/or the intermediate sheath). The inventors have surprisingly found that such compositions, relative to conventional polymers, achieve higher gas and particularly CO₂ permeability while retaining tensile properties. The metal elements and materials included within the flexible pipe are better protected from the corrosion of the acidic gases because the TPV compositions described herein advantageously provide better gas permeability as the gas diffuses faster through the lay ers of the flexible pipe.

For purposes of this disclosure, the terms “conduit”, “pipe”, “hose”, and “tube” can be used interchangeably.

For purposes of this disclosure, the terms “housing”, “sheath”, and “layer” can be used interchangeably.

For purposes of this disclosure, the terms “armoring layers,” “armoring elements,” and “reinforcing plies” can be used interchangeably.

For purposes of this disclosure, and unless otherwise indicated, a “composition” includes components of the composition and/or reaction products of two or more components of the composition.

### Articles

Certain embodiments of the present TPV compositions are used to form a layer made by extrusion and/or co-extrusion, blow molding, injection molding, thermo-forming, elasto-welding, compression molding and 3D printing, pultrusion, and other fabrication techniques. The layer can be co-extruded as a separate layer, or extruded as a tape and wrapped onto the pipe (e.g., a flexible pipe), such as an anti-wear layer or an insulation layer (e.g., a thermal insulation layer). The layer can be part of a flexible structure used to transport hydrocarbons extracted from an offshore deposit and/or can transport water, heated fluids, and/or chemicals injected into the formation in order to increase the production of hydrocarbons. In some embodiments, a TPV composition configured for use as at least a portion of a conduit may have a thickness in the range of from 2 millimeters (mm) to 30 mm, encompassing any value and subset therebetween.

The FIG. shows, schematically, a side view of a flexible pipe 100 according to some embodiments. The flexible pipe includes from inside out an inner pressure sheath 5, a first armor layer 4, an intermediate sheath 3, a second armor layer 2, and an outer sheath 1. The inner pressure sheath 5 contacts the oil and/or gas. The first armor layer 4 provides strength to the tube and can be made from, for example, one or more layers of metal and/or reinforced polymer (e.g., carbon nanotube reinforced polyvinylidene fluoride (PVDF)). Intermediate sheath 3 provides thermal insulation and/or anti-wear resistance. The intermediate sheath can be extruded as a single layer or extruded as a tape and then wrapped on to the flexible pipe. Second armor layer 2 provides strength and pressure resistance to the tube and can be made from, for example, one or more layers of metal. Outer sheath 1 protects the pipe structure and has the properties of abrasion resistance and fatigue resistance. The outer sheath 1 and/or intermediate sheath 3 is made from a material that includes one or more TPV compositions as described below.

Conventional materials used for the outer sheath 1 include high density polyethylene (HDPE), polyamide-11 (PA11), and polyamide-12 (PA12). The current polymeric materials used for outer sheath have extremely low permeability for the acid gases, thereby further exacerbating the corrosion. Conventional materials also show poor low temperature properties, poor crack propagation strength, limited fatigue strength, among other negative characteristics. These drawbacks have necessitated such materials to be compounded with plasticizers, such as n-butylbenzenesulfonamide (BBSA) that can migrate overtime resulting in embrittlement of the outersheath layer.

Conventional materials used for the intermediate sheath 3 include a single extruded layer or helically wrapped layers of extruded tapes of syntactic foams consisting of a polypropylene or polyurethane matrix with embedded non-polymeric (e.g., glass) (hallow) microspheres, HDPE, and PVDF. A major disadvantage for such syntactic PP foam tapes is that they involve two manufacturing steps: producing the insulation tape and winding the tape onto the pipe body. A further disadvantage of such extruded tapes include the corrosion of steel or metal wires forming the layers due to condensation of water vapor migrating from the inner layer through the insulation tapes. A still further disadvantage of existing insulation technology is that in the case of damage to the external sheath, the annulus of the flexible pipe can get flooded which increases the risk of corrosion of the metal armor wires. Moreover, such foamed polymeric insulation layers are prone to crushing under internal and external pressures operate to squeeze the tape layer thereby reducing its thickness and thermal insulation properties. Therefore, there is significant interest in providing an extrudable, dense thermal insulation layer with high permeability, and acceptable insulation properties.

A certain class of TPVs has been surprisingly found to provide an alternative and more robust material for the outer sheath and/or intermediate sheaths for fluid containment. As discussed below, and according to some embodiments, the TPV compositions useful as an outer sheath and/or intermediate sheath in flexible pipe includes a fully or partially crosslinked and/or cured rubber phase, a thermoplastic phase, a polyhedral oligomeric silsesquioxane, a filler, a plasticizer (e.g., an oil), and a curative. The cured rubber phase includes one or more of an ethylene-propylene rubber, a nitrile rubber, a butyl rubber, a halobutyl rubber, or a combination thereof, and the thermoplastic phase (e.g., a thermoplastic polyolefin) includes one or more of a propylene-based polymer, an ethylene-based polymer, a butene-1-based polymer, or a combination thereof.

Certain embodiments of the present disclosure include flexible pipes/conduits comprising polymeric layer sheaths, positioned as inner layers, intermediate layers (which can include a TPV composition), and/or outer layers (which can include a TPV composition) of: 1) unbonded or bonded flexible pipes, tubes and hoses similar to those described in American Petroleum Institute (API) Spec 171 and API Spec 17K, 2) thermoplastic hoses similar to those described in API 17E, and 3) thermoplastic composite pipes similar to those described in Det Norske Veritas (DNV) RP-F119. In other embodiments, the present thermoplastic vulcanizate composition is used in composite tapes (e.g., carbon fibers, carbon nanotubes or glass fibers embedded in a thermoplastic matrix) used in thermoplastic composite pipes with a structure similar to those described in DNV-RP-F119.

In some embodiments, the flexible pipe is a flexible underwater pipe.

In some embodiments, a flexible pipe includes an outer sheath including the TPV composition that is extruded onto an outer armor layer or onto an insulation layer of the unbonded flexible pipe. In some embodiments, the TPV composition is extruded as an outersheath layer having a thickness of from about 2 mm to about 30 mm.

In some embodiments the TPV compositions is a thermal insulating layer. The TPV compositions can possess highly advantageous properties such as low thermal conductivity, high gas permeability, and stable thermal conductivity over time. The thermal insulation layer can have a thickness in the range from about 2 mm to about 30 mm. In some embodiments the TPV composition is applied as a wound insulation layer, such as a layer wound from one or more tapes. The tapes can be extruded with any thickness, but in order to obtain an even surface the tapes advantageously possess thickness of up to about 10 mm, such as from about 0.1 to about 5 mm.

In some embodiment, the TPV composition can be an intermediate sheath between armor layers of the flexible pipe whereby the TPV based layer can protect the armor layers from abrasion damage as a wear layer. In some embodiments, a flexible pipe includes an intermediate sheath having a thickness of from 1 mm to 10 mm.

In some embodiments, a flexible pipe includes an inner pressure sheath; an inner housing or carcass; at least one armor layer (or reinforcing layer) at least partially disposed around the inner housing; and an outer sheath at least partially disposed around the at least one reinforcing layer.

In some embodiments, a flexible pipe includes a) an inner pressure sheath for confining the fluid to be transported by the pipe, b) at least one armoring layer (or reinforcing layer) at least partially disposed around the inner pressure sheath, c) at least one intermediate layer at least partially disposed around the at least one armoring layer, d) at least one outer sheath at least partially disposed around the at least one intermediate layer and/or at least one armoring layer.

Although the TPV compositions will be described as included in an outer sheath of a flexible pipe, it should be understood that the TPV compositions can, instead, be or additionally be included in other layers, e.g., an intermediate sheath, of a flexible pipe.

In some embodiments, the pipe is rigid. In some embodiments, a rigid pipe structure comprises a metallic based layer, and at least one layer comprising any TPV composition described herein. Rigid pipes can be useful for, e.g., wet insulation.

While the specification is described in embodiments of a flexible pipe, it should be understood that the specification is applicable to umbilicals, thermoplastic composite pipes, and thermoplastic hoses, flow lines, wet insulated pipes and the like.

### Formulations of the TPV Compositions

In some embodiments, the TPV composition can include an amount of a rubber such as ethylene propylene terpolymer rubber (such as EPDM rubber), nitrile rubber, butyl rubber, or a combination thereof, that is about 80 wt % or less of rubber, about 50 wt % or less of rubber, such as about 40 wt % or less of rubber, such as about 30 wt % or less based on a combined weight of the rubber and the thermoplastic polyolefin. In these or other embodiments, the amount of rubber within the TPV composition can be from about 10 wt % to about 80 wt %, such as from about 10 wt % to about 30 wt %, such as from about 12 wt % to about 25 wt %, such as from about 14 wt % to about 24 wt %, based on a combined weight of the rubber and the thermoplastic polyolefin. The rubber can be in a crosslinked or partially crosslinked form in the TPV composition.

In these and other embodiments, the TPV composition can include an amount of a thermoplastic phase (e.g., a thermoplastic polymer or a thermoplastic polyolefin), such as a propylene-based polymer, an ethylene-based polymer, a butene-1-based polymer, or a combination thereof, that is from about 20 wt % to about 90 wt % (such as from about 30 wt % to about 90 wt %, such as from about 50 wt % to about 90 wt %, such as from about 60 wt % to about 90 wt %) based on a combined weight of the rubber and the thermoplastic polyolefin. In some embodiments, the concentration of the thermoplastic polyolefin in the TPV composition is from about 20 wt % to about 80 wt %, such as from about 25 wt % to about 75 wt %, such as from about 27 wt % to about 70 wt %, such as from about 30 wt % to about 70 wt % based on the combined weight of the rubber and the thermoplastic polyolefin.

In some embodiments, the TPV composition cart include an amount of a polyhedral oligomeric silsesquioxane material(s) of about 0.1 wt % or more, such as from about 0.1 wt % to about 20 wt %, such as from about 1 wt % to about 15 wt %, such as from about 2 wt % to about 10 wt % based on a total weight of the TPV composition.

In some embodiments, where the thermoplastic phase may include a blend of propylene-based polymer and ethylene-based polymer, the thermoplastic phase may include from about 51 wt % to about 100 wt % of propylene-based polymer (such as from about 65 wt % to about 99.5 wt %, such as from about 85 wt % to about 99 wt %, such as from about 95 wt % to about 98 wt %) based on a total weight of the thermoplastic phase, with balance of the thermoplastic phase including an ethylene-based polymer. For example, in some embodiments, the thermoplastic phase may include from about 0 wt % to about 49 wt % of ethylene-based polymer (such as from about 1 wt % to about 15 wt %, such as from about 2 wt % to about 5 wt %) based on the total weight of the thermoplastic phase.

In some embodiments, tillers (such as calcium carbonate, clays, silica, talc, titanium dioxide, carbon black, a nucleating agent, mica, wood flour, and the like, and blends thereof, as well as inorganic and organic nanoscopic fillers) may be present in the TPV composition in an amount from about 0.1 wt % to about 10 wt % based on the total weight of the TPV composition (such as from about 1 wt % to about 7 wt %, such as from about 2 wt % to about 5 wt %). The amount of filler that can be used may depend, at least in part, upon the type of filler and the amount of extender oil that is used.

In some embodiments, an oil (e.g., an extender oil) may be present in the TPV composition in an amount from about 10 wt % to about 40 wt % by weight of combined TPV composition (such as from about 12 wt % to about 35 wt %, such as from about 14 wt % to about 32 wt %). The quantity of od added can depend on the properties desired, with an upper limit that may depend on the compatibility of the particular oil and blend ingredients; and this limit can be exceeded when excessive exuding of oil occurs. The amount of oil can depend, at least in part, upon the type of rubber. High viscosity rubbers are more highly od extendable. Where low molecular weight ester plasticizers are employed, the ester plasticizers are generally used in amounts of about 40 wt % or less, such as about 35 wt % or less based on total TPV composition.

In some embodiments, the TPV composition includes a curative. Amounts and types of curatives that are useful for the TPV compositions described herein are discussed below.

In some embodiments, and when employed, the TPV composition may include a processing additive (e.g., a polymeric processing additive) in an amount of from about 0.1 wt % to about 20 wt % based on the total weight of the TPV composition.

In some embodiments, the TPV composition may optionally include reinforcing and non-reinforcing fillers, colorants, antioxidants, nucleators, stabilizers, rubber processing oil, lubricants, antiblocking agents, anti-static agents, waxes, foaming agents, pigments, flame retardants, antistatic agents, slip masterbatches, siloxane based slip agents (e.g., Dow Corning™ HMB-0221 Masterbatch available from Dow Chemical Company) ultraviolet inhibitors, antioxidants, and other processing aids known in the rubber and TPV compounding art. These additives can be used in the TPV compositions at an amount up to about 20 wt % of the total weight of the TPV composition.

### Polyhedral Oligomeric Silsesquioxane

The TPV compositions include a polyhedral oligomeric silsesquioxane (POSS) compound. POSS compounds are monodisperse nanostructured chemicals. POSS compounds have hybrid (e.g., organic-inorganic) compositions in which the internal frameworks are primarily comprised of inorganic silicon-oxygen bonds. The exterior of the nanostructure includes both reactive and/or nonreactive organic functionalities (R), which ensure compatibility and tailorability of the nanostructure with organic polymers. POSS compounds can be of low density, may exhibit excellent fire retardancy, and can range in diameter from, e.g., from about 0.5 nm to about 50 nm.

In some embodiments, the POSS compounds have specific organic groups that are selected to ensure compatibility with the other materials of the TPV compositions.

POSS compounds are compounds represented by the formula

[RSiO_{1.5}]ₓ

where x is an integer (such as from about 2 to about 36, such as from about 4 to about 24, such as from about 4 to about 15, such as from about 6 to about 12) representing molar degree of polymerization, and each instance of R represents a substituent (e.g., each instance of R independently selected from H, siloxy, hydrocarbyl, cyclic or linear, saturated or unsaturated, aliphatic or aromatic groups, that may additionally include reactive functionalities such as alcohols, thiols, esters, amines, amides, aldehydes, ketones, olefins, ethers, thioethers, epoxides, carbamates, carbonates, acid anhydrides, carboxylic acids, acyl halides, amines, nitriles, imines, isocyanates, nitro, arenes, or halides). The hydrocarbyl group can be alkyl (such as from C1 to C10), alkenyl (such as from C2 to C10), alkynyl (such as from C2 to C10), aryl (such as phenyl and benzyl), or heteroaryl.

In some embodiments, the R group of each RSiO_{1.5} group may be the same group (known as a homoleptic system) or a different group (known as a heteroleptic system).

In some embodiments, POSS compounds can further be of the functionalized heteroleptic type represented by

[RSiO_{1.5})ₙ(RXSiO_{1.0})ₘ]

where m and n are integers, and m+n≤about 36 representing molar degree of polymerization, and each instance of R is the same as defined above and X includes but is not limited to OH, Cl, Br, I, alkoxide (OR), acetate (OOCR), peroxide (OOR), amine (NR₂), and isocyanate (NCO).

In some embodiments, the POSS molecular silicas are of different sizes with functionalities that are compatible with the composition of TPV. Exemplary polyhedral oligomeric silsesquioxanes include: [(RSiO_{1.5})₆], [(RSiO_{1.5})₈], [(RSiO_{1.5})₁₀], and [(RSiO_{1.5})₁₂] where each R group is the same or different.

Other exemplary polyhedral oligomeric silsesquioxanes include: octamethyl POSS ([(CH₃SiO_{1.5})₈] (MS0830), octaisobutyl POSS ([((CH₃)₂CHCH₂SiO_{1.5})₈]) (MS0825), and octavinyl POSS ([(CH₂CHSiO_{1.5})ₙ]) both available from Hybrid Plashes Inc. (Hattiesburg, Miss., U.S.).

In some embodiments, the polyhedral oligomeric silsesquioxane is blended (e.g., by mechanical means) into the TPV compositions. In some embodiments, the polyhedral oligomeric silsesquioxane exists in the thermoplastic phase, the rubber phase, or a combination thereof.

### Rubber Phase

Rubbers that may be employed to form the rubber phase include those polymers that are capable of being cured or crosslinked by a phenolic resin or a hydrosilylation curative (e.g., silane-containing curative), a peroxide with a coagent, a moisture cure via silane grafting, or an azide. Reference to a rubber may include mixtures of more than one rubber. Non-limiting examples of rubbers include olefinic elastomeric terpolymers, nitriles, butyl rubbers (such as isobutylene-isoprene rubber (IIR), brominated isobutylene-isoprene rubber (BIIR), and isobutylene paramethyl styrene rubber (BIMSM)), and mixtures thereof. In some embodiments, olefinic elastomeric terpolymers include ethylene-based elastomers such as ethylene-propylene-non-conjugated diene rubbers.

### 1. Ethylene-Propylene Rubber

The term ethylene-propylene rubber refers to rubbery terpolymers polymerized from ethylene, at least one other α-olefin monomer, and at least one diene monomer (for example, an ethylene-propylene-diene terpolymer or an EPDM terpolymer). The α-olefin monomer may include propylene, 1-butene, 1-hexene, 4-methyl-1-pentane, 1-octene, 1-decene, or a combination thereof. In one embodiment, the α-olefins include propylene, 1-hexene, 1-octene or a combination thereof. The diene monomers may include 5-ethylidene-2-norbornene (ENB); 5-vinyl-2-norbornene (VNB); divinylbenzene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; or a combination thereof. Polymers prepared from ethylene, α-olefin monomer, and diene monomer may be referred to as a terpolymer or even a tetrapolymer in the event that multiple α-olefin monomers or diene monomers are used.

In some embodiments, where the diene monomer includes 5-ethylidene-2-norbornene (ENB) or 5-vinyl-2-norbornene (VNB), the ethylene-propylene rubber may include at least about 1 wt % of diene monomer (such as at least about 3 wt %, such as at least about 4 wt %, such as at least about 5 wt %, such as at least about 10 wt %) based on the total weight of an ethylene-propylene rubber. In other embodiments, where the diene includes ENB or VNB, the ethylene-propylene rubber may include from about 1 wt % to about 15 wt % of diene monomer (such as from about 3 wt % to about 15 wt %, such as from about 5 wt % to about 12 wt %, such as from about 7 wt % to about 11 wt %) based on the total weight of the ethylene-propylene rubber.

In some embodiments, the ethylene-propylene rubber includes one or more of the following:

1) An ethylene-derived content that is from about 10 wt % to about 99.9 wt %, (such as from about 10 wt % to about 90 wt %, such as from about 12 wt % to about 90 wt %, such as from about 15 wt % to about 90 wt %, such as from about 20 wt % to about 80 wt %, such as from about 40 wt % to about 70 wt %, such as from about 45 wt % to about 65 wt %, based on the total weight of the ethylene-propylene rubber. In some embodiments, the ethylene-derived content is from about 40 wt % to about 85 wt %, such as from about 40 wt % to about 85 wt % based on the total weight of the ethylene-propylene rubber.
2) A diene-derived content that is from about 0.1 to about to about 15 wt %, such as from about 0.1 wt % to about 5 wt %, such as from about 0.2 wt % to about 10 wt %, such as from about 2 wt % to about 8 wt %, or from about 4 wt % to about 12 wt %, such as from about 4 wt % to about 9 wt %) based on the total weight of the ethylene-propylene rubber, in some embodiments, the diene-derived content is from about 3 wt % to about 15 wt % based on the total weight of the ethylene-propylene rubber.
3) The balance of the ethylene-propylene rubber including α-olefin-derived content (e.g., C₂ to C₄₀, such as C₃ to C₂₀, such as C₃ to C₁₀ olefins, such as propylene).
4) A weight average molecular weight (Mw) that is about 100,000 g/mol or more (such as about 200,000 g/mol or more, such as about 400,000 g/mol or more, such as about 600,000 g/mol or more). In these or other embodiments, the Mw is about 1,200,000 g/mol or less (such as about 1,000,000 g/mol or less, such as about 900,000 g/mol or less, such as about 800,000 g/mol or less). In these or other embodiments, the Mw can be from about 400,000 g/mol to about 3,000,000 g/mol (such as from about 400,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol).
5) A number average molecular weight (Mn) that is about 20,000 g/mol or more (such as about 60.000 g/mol or more, such as about 100,000 g/mol or more, such as about 150,000 g/mol or more). In these or other embodiments, the Mn is less than about 500,000 g/mol (such as about 400,000 g/mol or less, such as about 300,000 g/mol or less, such as about 250,000 g/mol or less).
6) A Z-average molecular weight (Mz) that is from about 10,000 g/mol to about 7,000,000 g/mol (such as from about 50,000 g/mol to about 3,000,000 g/mol, such as from about 70,000 g/mol to about 2,000,000 g/mol, such as from about 75,000 g/mol to about 1,500,000 g/mol, such as from about 80,000 g/mol to about 700,000 g/mol, such as from about 100,000 g/mol to about 500,000 g/mol).
7) A polydispersity index (Mw/Mn; PDI) that is from about 1 to about 10 (such as from about 1 to about 5, such as from about 1 to about 4, such as from about 2 to about 4 or from about 1 to about 3, such as from about 1.8 to about 3 or from about 1 to about 2, or from about 1 to about 2.5).
8) A dry Mooney viscosity (ML₍₁₊₄₎ at 125° C.) per ASTM D-1646, that is from about 10 MU to about 500 MU or from about 50 MU to about 450 MU. In these or other embodiments, the Mooney viscosity is 250 MU or more, such as 350 MU or more.
9) A glass transition temperature (T_{g}), as determined by Differential Scanning Calorimetry (DSC) according to ASTM E 1356, that is about −20° C. or less (such as about −30° C. or less, such as about −50° C. or less). In some embodiments, T_{g} is from about −20° C. to about −60° C.

The ethylene-propylene rubber may be manufactured or synthesized by using a variety of techniques. For example, these terpolymers can be synthesized by employing solution, slurry, or gas phase polymerization techniques or a combination thereof that employ various catalyst systems including Ziegler-Natta systems including vanadium catalysts and take place in various phases such as solution, slurry, or gas phase. Exemplary catalysts include single-site catalysts including constrained geometry catalysts involving Group IV-VI metallocenes. In some embodiments, the EPDMs can be produced via a conventional Zeigler-Natta catalyst using a slurry process, especially those including Vanadium compounds, as disclosed in U.S. Pat. No. 5,783,645, as well as metallocene catalysts, which are also disclosed in U.S. Pat. No. 5,756,416. Other catalysts systems such as the Brookhart catalyst system may also be employed. Optionally, such EPDMs can be prepared using the above catalyst systems in a solution process.

Some elastomeric terpolymers are commercially available under the tradenames Vistalon™ (ExxonMobil Chemical Co.; Houston, Tex.), Keltan™ (Arlanxeo Performance Elastomers; Orange, Tex.), Nordel™ IP (Dow), NORDEL MG™ (Dow), Rovalene™ (Lion Elastomers), KEP (Kumho Polychem), and Suprene™ (SK Global Chemical). Specific examples include Vistalon 3666, Vistalon 9600, Keltan 9950C, Keltan 8550C, KEP 8512, KEP 9590, Keltan 5469 Q, Keltan 4969 Q, Keltan 5469 C, and Keltan 4869 C, Royalene 694, Rovalene 677, Suprene 512F, Nordel 6555, Nordel 4571XFM, Rovalene 515.

In some embodiments, the ethylene propylene rubber may be obtained in an oil extended form, with about a 50 phr to about 200 phr process oil, such as about 75 phr to about 120 phr process oil on the basis of 100 phr of elastomer.

### 2. Nitrile Rubber

Suitable nitrile rubbers include rubbery polymers of 1,3-butadiene or isoprene and acrylonitrile. Exemplary nitrile rubbers include polymers of 1,3-butadiene and about 20-50 weight percent acrylonitrile.

In some embodiments, the nitrile rubber includes one or more of the following characteristics:

1) An acrylonitrile-derived content that is about 20 wt % or more (such as from about 20 wt % to about 50 wt %, 25 wt % to about 45 wt %, such as from 30 wt % to about 40 wt %, such as from about 35 wt % to about 40 wt %) based on the total weight of the nitrile rubber.
2) Where the nitrile rubber is a copolymer of isoprene and acrylonitrile, an isoprene-derived content that is from about 10 wt % to about 99.9 wt %, (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the composition.
3) Where the nitrile rubber is a copolymer of 1,3-butadiene and acrylonitrile, a 1,3-butadiene-derived content that is from about 10 wt % to about 99.9 wt % (such as from about 10 wt % to about 90 wt %, such as from 12 wt % to about 90 wt %, such as from about 15 wt % to about 90 wt % such as from about 20 wt % to about 80 wt %, such as from about 40 wt % to about 70 wt %, such as from about 50 wt % to about 70 wt %, such as from about 55 wt % to about 65 wt %, such as from about 60 wt % and about 65 wt %) based on the total weight of the ethylene-propylene rubber. In some embodiments, the ethylene-derived content is from about 40 wt % to about 85 wt %, such as from about 40 wt % to about 85 wt %, based on the total weight of the composition.
4) A weight average molecular weight (Mw) that is about 100,000 g/mol or more (such as about 200,000 g/mol or more, such as about 400,000 g/mol or more, such as about 600,000 g/mol or more), in these or other embodiments, the Mw is about 1,200,000 g/mol or less (such as about 1,000,000 g/mol or less, such as about 900,000 g/mol or less, such as about 800,000 g/mol or less). In these or other embodiments, the Mw can be from about 500,000 g/mol to about 3,000,000 g/mol (such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol).

Nitrile rubber can be obtained from a number of commercial sources as disclosed in the Rubber World Blue Book.

A functionalized nitrile rubber having one or more graft forming functional groups may be used for preparing block copolymer of the present disclosure. The aforesaid “graft forming functional groups” are different from and are in addition to the olefinic and cyano groups normally present in nitrile rubber. Carboxylic-modified nitrile rubbers having carboxy groups and amine-modified nitrile rubbers having amino groups are also useful for the TPV compositions described herein.

### 3. Butyl Rubber

in some embodiments, butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include α-methylstyrene and paramethylstyrene. These copolymers and terpolymers may also be halogenated butyl rubbers (also known as halobutyl rubbers) such as in the case of chlorinated butyl rubber and brominated butyl rubber. In some embodiments, these halogenated polymers may derive from monomer such as parabromomethylstyrene.

In some embodiments, butyl rubber includes copolymers of isobutylene and isoprene, and copolymers of isobutylene and paramethyl styrene, terpolymers of isobutylene, isoprene, and vinylstyrene, branched butyl rubber, and brominated copolymers of isobutene and paramethylstyrene (yielding copolymers with parabromomethylstyrenyl mer units). These copolymers and terpolymers may be halogenated. Exemplary butyl rubbers include isobutylene-isoprene rubber (IIR), brominated isobutylene-isoprene rubber (BIIR), chlorinated isobutylene-isoprene rubber (CIIR), and isobutylene paramethyl styrene rubber (BIMSM).

In some embodiments, the butyl rubber includes one or more of the following characteristics:
1) Where butyl rubber includes the isobutylene-isoprene rubber, the rubber may include isoprene in an amount from about 0.5 wt % to about 30 wt % (such as from about 0.8 wt % to about 5 wt %) based on the entire weight of the rubber with the remainder being isobutylene.
2) Where butyl rubber includes isobutylene-paramethylstyrene rubber, the rubber may include paramethylstyrene in an amount from about 0.5 wt % to about 25 wt % (such as from about 2 wt % to about 20 wt %) based on the entire weight of the rubber with the remainder being isobutylene.
3) Where the isobutylene-paramethylstyrene rubbers are halogenated, such as with bromine and/or chlorine, these halogenated rubbers can have a percent by weight halogenation of from about 0 wt % to about 10 wt % (such as from about 0.3 wt % to about 7 wt %) based on the entire weight of the rubber with the remainder being isobutylene.
4) Where the isobutylene-isoprene rubbers are halogenated, such as with bromine and/or chlorine, these halogenated rubbers can have a percent by weight halogenation of from about 0 wt % to about 10 wt % (such as from about 0.3 wt % to about 7 wt %) based on the entire weight of the rubber with the remainder being isobutylene.
5) Where butyl rubber includes isobutylene-isoprene-divinylbenzene, the rubber may include isobutylene in an amount from about 95 wt % to about 99 wt % (such as from about 96 wt % to about 98.5 wt %) based on the entire weight of the rubber, and isoprene from about 0.5 wt % to about 5 wt % (such as from about 0.8 wt % to about 2.5 wt %) based on the entire weight of the rubber, with the balance being divinylbenzene.
6) Where the butyl rubber includes halogenated butyl rubbers, the butyl rubber may include from about 0.1 wt % to about 10 wt % halogen (such as from about 0.3 wt % to about 7 wt %, such as from about 0.5 wt % to about 3 wt %) based upon the entire weight of the rubber.
7) A glass transition temperature (T_{g}) that is about −55° C. or less (such as about −58° C. or less, such as about −60° C. or less, such as about −63° C. or less).
8) A weight average molecular weight (Mw) that is about 100,000 g/mol or more (such as about 200,000 g/mol or more, such as about 400,000 g/mol or more, such as about 600,000 g/mol or more). In these or other embodiments, the Mw is about 1,200,000 g/mol or less (such as about 1,000,000 g/mol or less, such as about 900,000 g/mol or less, such as about 800,000 g/mol or less). In these or other embodiments, the Mw can be from about 500,000 g/mol to about 3,000,000 g/mol (such as from about 500,000 g/mol to about 2,000,000, such as from about 500,000 g/mol to about 1,500,000 g/mol, such as from about 600,000 g/mol to about 1,200,000 g/mol, such as from about 600,000 g/mol to about 1,000,000 g/mol).

Butyl rubber can be obtained from a number of commercial sources as disclosed in the Rubber World Blue Book. For example, both halogenated and un-halogenated rubbers/copolymers of isobutylene and isoprene are available under the tradename Exxon Butyl™ (ExxonMobil Chemical Co.), halogenated and un-halogenated copolymers of isobutylene and paramethylstyrene are available under the tradename EXXPRO™ (ExxonMobil Chemical Co.), star branched butyl rubbers are available under the tradename STAR BRANCHED BUTYL™ (ExxonMobil Chemical Co.), and copolymers having parabromomethylstyrenyl mer units are available under the tradename EXXPRO 3745 (ExxonMobil Chemical Co.). Halogenated and non-halogenated terpolymers of isobutylene, isoprene, and divinylstyrene are available under the tradename Polysar Butyl™ (Lanxess: Germany).

In some embodiments, the rubber (e.g., ethylene-propylene rubber, nitrile rubber, or butyl rubber) can be highly cured. In some embodiments, the rubber is advantageously partially or fully (completely) cured. The degree of cure can be measured by determining the amount of rubber that is extractable from the TPV composition by using cyclohexane or boiling xylene as an extractant. This method is disclosed in U.S. Pat. No. 4,311,628, which is incorporated herein by reference for purposes of U.S. patent practice. In some embodiments, the rubber has a degree of cure where not more than about 5.9 wt %, such as not more than about 5 wt %, such as not more than about 4 wt %, such as not more than about 3 wt % is extractable by cyclohexane at 23° C. as described in U.S. Pat. Nos. 5,100,947 and 5,157,081, which are incorporated herein by reference for purpose of U.S. patent practice. In these or other embodiments, the rubber is cured to an extent where greater than about 94 wt %, such as greater than about 95 wt %, such as greater than about 96 wt %, such as greater than about 97 wt % by weight of the rubber is insoluble in cyclohexane at 23° C. Alternately, in some embodiments, the rubber has a degree of cure such that the crosslink density is at least 4×10⁻⁵ moles per milliliter of rubber, such as at least 7×10⁻⁵ moles per milliliter of rubber, such as at least 10×10⁻⁵ moles per milliliter of rubber. See also “Crosslink Densities and Phase Morphologies in Dynamically Vulcanized TPEs,” by Ellul et al., RUBBER CHEMISTRY AND TECHNOLOGY, Vol. 68, pp. 573-584 (1995).

Despite the fact that the rubber may be partially or fully cured, the compositions of this disclosure can be processed and reprocessed by conventional plastic processing techniques such as extrusion, injection molding, blow molding, and compression molding. The rubber within these thermoplastic elastomers can be in the form of finely-di vided and well-dispersed particles of vulcanized or cured rubber within a continuous thermoplastic phase or matrix. In some embodiments, a co-continuous morphology or a phase inversion can be achieved. In those embodiments where the cured rubber is in the form of finely-divided and well-dispersed particles within the thermoplastic medium, the rubber particles can have an average diameter that is about 50 μm or less (such as about 30 μm or less, such as about 10 μm or less, such as about 5 μm or less, such as about 1 μm or less). In some embodiments, at least about 50% of the particles, such as about 60% of the particles, such as about 75% of the particles have an average diameter of about 5 μm or less, such as about 2 μm or less, such as about 1 μm or less.

### Thermoplastic Phase

In some embodiments, the thermoplastic phase of the TPV compositions useful in outer sheaths of flexible pipes include a polymer that can flow above its melting temperature. In some embodiments, the major component of the thermoplastic phase includes at least one thermoplastic polyolefin such as a polypropylene (such as a homopolymer, random copolymer, or impact copolymer, or combination thereof), an ethylene-based polymer (e.g., a polyethylene), a butene-based polymer (e.g., a polybutene), or a combination thereof. In some embodiments, the thermoplastic phase may also include, as a minor constituent, at least one thermoplastic polyolefin such as an ethylene-based polymer (e.g., polyethylene), a propylene-based polymer (e.g., polypropylene), or a butene-based polymer (e.g., a poly butene or a poly butene-1).

### 1. Propylene-Based Polymer

Propylene-based polymers include those solid, generally high molecular weight plastic resins that primarily include units deriving from the polymerization of propylene. In some embodiments at least 75%, in other embodiments at least 90%, in other embodiments at least 95%, and in other embodiments at least 97% of the units of the propylene-based polymer derive from the polymerization of propylene, in particular embodiments, these polymers include homopolymers of propylene. Homopolymer polypropylene can include linear chains and/or chains with long chain branching.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, described above, or with C₁₀-C₂₀ olefins.

In some embodiments, the propylene-based polymer includes one or more of the following characteristics:

1) The propylene-based polymers may include semi-crystalline polymers. In some embodiments, these polymers may be characterized by a crystallinity of at least about 25 wt % or more (such as about 55 wt % or more, such as about 65 wt % or more, such as about 70 wt % or more). Crystallinity may be determined by dividing the heat effusion (Hf) of a sample by the heat of fusion of a 100% crystalline polymer, which is assumed to be 209 joules/gram for polypropylene.
2) A Hf that is about 52.3 J/g or more (such as about 100 J/g or more, such as about 125 J/g or more, such as about 140 J/g or more).
3) A weight average molecular weight (Mw) that is from about 50,000 g/mol to about 2,000,000 g/mol (such as from about 100,000 g/mol to about 1,000,000 g/mol, such as from about 100,000 g/mol to about 600,000 g/mol or from about 400,000 g/mol to about 800,000 g/mol) as measured by GPC with polystyrene standards.
4) A number average molecular weight (Mn) that is from about 25,000 g/mol to about 1,000,000 g/mol (such as from about 50,000 g/mol to about 300,000 g/mol) as measured by GPC with polystyrene standards.
5) A g′ᵥᵢₛ that is 1 or less (such as 0.9 or less, such as 0.8 or less, such as 0.6 or less, such as 0.5 or less).
6) A melt mass flow rate (MFR) (ASTM D1238, 2.16 kg weight@230° C.) that is about 0.1 g/10 min or more (such as about 0.2 g/10 min or more, such as about 0.2 g/10 min or more). Alternately, the MFR is from about 0.1 g/10 mm to about 50 g/10 mm, such as from about 0.5 g/10 min to about 5 g/10 mm, such as from about 0.5 g/10 min to about 3 g/10 min. 7) A melt temperature (Tₘ) that is from about 110° C. to about 170° C. (such as from about 140° C. to about 168° C., such as from about 160° C. to about 165° C.).
8) A glass transition temperature (T_{g}) that is from about −50° C. to about 10° C. (such as from about −30° C. to about 5° C., such as from about −20° C. to about 2° C.).
9) A crystallization temperature (T_{g}) that is about 75° C. or more (such as about 95° C. or more, such as about 100° C. or more, such as about 105° C. or more (such as from about 105° C. to about 130° C.).

In some embodiments, the propylene-based polymers include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. In some embodiments, polypropylene resins may be characterized by a MFR (ASTM D-1238; 2.16 kg@230° C.) that is about 10 dg/min or less (such as about 1.0 dg/min or less, such as about 0.5 dg/min or less).

In some embodiments, the polypropylene includes a homopolymer, random copolymer, or impact copolymer polypropylene or combination thereof. In some embodiments, the polypropylene is a high melt strength (HMS) long chain branched (LCR) homopolymer polypropylene.

The propylene-based polymers may be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions described herein include ExxonMobil™ PP5341 (available from ExxonMobil); Achieve™ PP6282NE1 (available from ExxonMobil) and/or polypropylene resins with broad molecular weight distribution as described in U.S. Pat. Nos. 9,453,093 and 9,464,178; and other polypropylene resins described in US20180016414 and US20180051160; Waymax MFX6 (available from Japan Polypropylene Corp.); Borealis Daploy™ WB140 (available from Borealis AG); and Braskem Ampleo 1025MA and Braskem Ampleo 1020GA (available from Braskem Ampleo), and other suitable polypropylenes.

In one or more embodiments, the thermoplastic component is or includes isotactic polypropylene, in some embodiments, the thermoplastic component contains one or more crystalline propylene homopolymers or copolymers of propylene having a melting temperature of from about 110° C. to about 170° C. or higher as measured by DSC, Example copolymers of propylene include, but are not limited to, terpolymers of propylene, impact copolymers of propylene, random polypropylene and mixtures thereof. Example comonomers have about 2 carbon atoms or from about 4 to about 12 carbon atoms. In some embodiments, the comonomer is ethylene.

The term “random polypropylene” as used herein broadly means a single phase copolymer of propylene having up to about 9 wt %, such as from about 2 wt % to about 8 wt % of an alpha olefin comonomer. Example alpha olefin comonomers have about 2 carbon atoms or from about 4 to about 12 carbon atoms. In some embodiments, the alpha olefin comonomer is ethylene.

In one or more embodiments, the thermoplastic resin component can be or include a “propylene-based copolymer.” A “propylene-based copolymer” includes at least two different types of monomer units, one of which is propylene. Suitable monomer units include, but are not limited to, ethylene and higher alpha-olefins ranging from C₄ to C₂₀, such as, for example, 1-butene, 4-methyl-1-pentene, 1-hexene or 1-octene and I-decene, or mixtures thereof, for example. In some embodiments, ethylene is copolymerized with propylene, so that the propylene-based copolymer includes propylene-derived units (units on the polymer chain derived from propylene monomers) and ethylene-derived units (units on the polymer chain derived from ethylene monomers).

### 2. Ethylene-Based Polymer

Ethylene-based polymers include those solid, generally high-molecular weight plastic resins that primarily include units derived from the polymerization of ethylene. In some embodiments, at least 90%, m other embodiments at least 95%, and in other embodiments at least 99% of the units of the ethylene-based polymer derive from the polymerization of ethylene. In particular embodiments, these polymers include homopolymers of ethylene.

In some embodiments, the ethylene-based polymers may also include units deriving from the polymerization of α-olefin comonomer such as propylene, 1-butene, I-hexene, 1-octene, 2-methyl-1-propene, 3-methyl-1-pentene, 4-methyl-1-pentene, 5-methyl-1-hexene, and mixtures thereof.

In some embodiments, the ethylene-based polymer includes one or more of the following characteristics:

1) A melt index (MI) (ASTM D-1238, 2.16 kg@190° C.) that is from about 0.1 dg/min to about 1,000 dg/min (such as from about 1.0 dg/min to about 200 dg/min, such as from about 7.0 dg/min to about 20.0 dg/min).
2) A melt temperature (Tₘ) that is from about 140° C. to about 90° C. (such as from about 135° C. to about 125° C., such as from about 130° C. to about 120° C.).

The ethylene-based polymers may be synthesized by using an appropriate polymerization technique known in the art such as the conventional Ziegler-Natta type polymerizations, and catalysis employing single-site organometallic catalysts including metallocene catalysts. Some ethylene-based polymers are commercially available. Ethylene-based copolymers are commercially available under the trade name ExxonMobil™ Polyethylene (available from ExxonMobil of Houston, Tex.), which include metallocene produced linear low density polyethylene including Exceed™, Enable™, and Exceed™ XP. Examples of ethylene-based thermoplastic polymers useful for certain embodiments of the present TPV compositions described herein include ExxonMobil HD7800P, ExxonMobil HD6706.17, ExxonMobil HD7960.13, ExxonMobil HD9830, ExxonMobil AD60-007, Exceed XP 8318ML, Exceed™ XP 6056ML, Exceed 1018HA, Enable™ 2010 Series, Enable™ 2305 Series, and ExxonMobil™ LLDPE LL (e.g. 1001, 1002YB, 3003 Series), all available from ExxonMobil of Houston, Tex. Additional examples of ethylene-based thermoplastic polymers useful for certain embodiments of the present TPV compositions described herein include Innate™ ST50 and Dowlex™, available from The Dow Chemical Company of Midland, Me.

In some embodiments, the ethylene-based polymer includes a low density polyethylene, a linear low density polyethylene, or a high density polyethylene. In some embodiments, the ethylene-based polymer can be a high melt strength (HMS) long chain branched (LCB) homopolymer polyethylene.

### 3. Butene-1-Based Polymer

Butene-1-based polymers include those solid, generally high molecular weight isotactic butene-1 resins that primarily include units deriving from a polymerization of butene-1.

In some embodiments, the butene-1-based polymers include isotactic poly(butene-1) homopolymers. In some embodiments, the butene-1-based polymers may also include units deriving from the polymerization of α-olefin comonomer such as ethylene, propylene, 1-butene, 1-hexane, 1-octene, 4-methyl-1-pentene, 2-methyl-1-propene, 3-methy-1-pentene, 4-methyl-1-pentene, 5-methyl-hexene, and mixtures of two or more thereof.

In some embodiments, the butene-1-based polymer includes one or more of the following characteristics:

1) At least 90 wt % or more of the units of the butene-1-based polymer derive from the polymerization of butene-1 (such as about 95 wt % or more, such as about 98 wt % or more, such as about 99 wt % or more). In some embodiments, these polymers include homopolymers of butene-1.
2) A melt index (ML) (ASTM D1238, 2.16 kg@190° C.) that is about 0.1 dg/min to 800 dg/min (such as from about 0.3 dg/min to about 200 dg/min, such as from about 0.3 dg/min to about 4.0 dg/min). In these or other embodiments, a MI of about 500 dg/min or less (such as about 100 dg/min or less, such as about 10 dg/min or less, such as about 5 dg/min or less).
3) A melt temperature (Tₘ) that is from about 130° C. to about 110° C. (such as from about 125° C. to about 115° C., such as from about 125° C. to about 120° C.).
4) A density, as determined according to ASTM D792, that is from about 0.897 g/ml to about 0.920 g/ml, such as from about 0.910 g/ml to about 0.920 g/ml. In these or other embodiments, a density that is about 0.910 g/ml or more, such as 0.915 g/ml or more, such as about 0.917 g/ml or more.

The butene-1-based polymers may be synthesized by using an appropriate polymerization technique known in the art such as the conventional Ziegler-Natta type polymerizations, and catalysis employing single-site organometallic catalysts including metallocene catalysts. Some butene-1-based polymers are commercially available. For example, some isotactic poly(l-butene) is commercially available under the tradename Poly butene Resins or PB (Based).

### Other Constituents

In some embodiments, the TPV compositions useful in outer sheaths of flexible pipes may include a polymeric processing additive. The processing additive may be a polymeric resin that has a very high melt flow index. These polymeric resins include both linear and branched polymers that have a melt flow rate that is about 500 dg/min or more, such as about 750 dg/min or more, such as about 1000 dg/min or more, such as about 1200 dg/min or more, such as about 1500 dg/min or more. Mixtures of various branched or various linear polymeric processing additives, as well as mixtures of both linear and branched polymeric processing additives, can be employed. Reference to polymeric processing additives can include both linear and branched additives unless otherwise specified. Linear polymeric processing additives include polypropylene homopolymers, and branched polymeric processing additives include diene-modified polypropylene polymers. TPY compositions that include similar processing additives are disclosed in U.S. Pat. No. 6,451,915, which is incorporated herein by reference for purpose of U.S. patent practice.

Fillers and extenders that can be utilized include conventional inorganics such as calcium carbonate, clays, silica, talc, titanium dioxide, carbon black, a nucleating agent, mica, wood flour, and the like, and blends thereof, as well as inorganic and organic nanoscopic fillers.

### Nucleating Agent

The term “nucleating agent” means any additive that produces a nucleation site for thermoplastic crystals to grow from a molten state to a solid, cooled structure. In other words, nucleating agents provide sites for growing thermoplastic crystals upon cooling the thermoplastic from its molten state.

The nucleating agent provides a plurality of nucleating sites for the thermoplastic component to crystallize when cooled. Surprisingly, this plurality of nucleating sites promotes even crystallization within the thermoplastic vulcanizate composition, allowing the composition to crystallize throughout an entire cross section in less time and at higher temperature. This plurality of nucleating site produces a greater amount of smaller crystals within the thermoplastic vulcanizate composition which require less cooling time.

This even cooling distribute enables the formation of extruded articles of the present TPV compositions having a thickness greater than 2 mm, such as greater than 5 mm, greater than 10 mm, and even greater than 13 mm. Extruded articles of the present TPV compositions can have thicknesses greater than 20 mm and still exhibit effective cooling (e.g., cooling from an outer surface of the cross section to an inner surface of the cross section) at extrusion temperatures without sacrificing mechanical strength. Such extrusion temperatures are at or above the melting point of the thermoplastic component. Illustrative nucleating agents include, but are not limited to dibenzylidene sorbitol based compounds, sodium benzoate, sodium phosphate salts, as well as lithium phosphate salts. For example, the nucleating agent may include sodium 2,2′-methylene-bis-(2,6-di-tert-butylphenyl)phosphate which is commercially available from Milliken & Company of Spartanburg, S.C. under the trade name Hyperform™, Another specific nucleating agent is norbornane (bicyclo(2.2.1)heptane carboxylic acid salt, which is commercially available from CIBA Specialty Chemicals of Basel, Switzerland.

### Processing Oils/Plasticizers

In some embodiments, the TPV composition may include a plasticizer such as an oil, such as a mineral oil, a synthetic oil, or a combination thereof. These oils may also be referred to as plasticizers or extenders. Mineral oils may include aromatic, naphthenic, paraffinic, and isoparaffinic oils, synthetic oils, and a combination thereof. In some embodiments, the mineral oils may be treated or untreated. Useful mineral oils can be obtained under the tradename SUNPAR™ (Sun Chemicals). Other oils are available under the tradename PARALUX™ (Chevron), and PARAMOUNT™ (Chevron). Other oils that may be used include hydrocarbon oils and plasticizers, such as synthetic plasticizers. Many additive oils are derived from petroleum fractions, and have particular ASTM designations depending on whether they fall into the class of paraffinic, naphthenic, or aromatic oils. Other types of additive oils include alpha olefinic synthetic oils, such as liquid polybutylene and polyisobutylene. Additive oils other than petroleum based oils can also be used, such as oils derived from coal tar and pine tar, as well as synthetic oils, e.g., polyolefin materials. Other plasticizers include triisononyl trimellitate (TINTM). In addition, vegetable or animal oils may be also used as plasticizer and/or processing aid in the TPV composition.

Examples of oils include base stocks. According to the American Petroleum Institute (API) classifications, base stocks are categorized in five groups based on their saturated hydrocarbon content, sulfur level, and viscosity index (Table 1). Lube base stocks are typically produced in large scale from non-renewable petroleum sources. Group I, II, and III base stocks are all derived from crude oil via extensive processing, such as solvent extraction, solvent or catalytic dewaxing, and hydroisomerization, hydrocracking and isodewaxing, isodewaxing and hydrofinishing. See “New Lubes Plants Use State-of-the-Art Hydrodewaxing Technology” in Oil & Gas Journal, Sep. 1, 1997; Krishna et al., “Next Generation Isodewaxing and Hydrofinishing Technology for Production of High Quality Base Oils”, 2002 NPRA Lubricants and Waxes Meeting, Nov. 14-15, 2002; Gedeon and Yenni, “Use of “Clean” Paraffinic Processing Oils to Improve TPE Properties”, Presented at TPEs 2000 Philadelphia, Pa., Sep. 27-28, 1999.

Group III base stocks can also be produced from synthetic hydrocarbon liquids obtained from natural gas, coal or other fossil resources, Group TV base stocks are polyalphaolefins (PAOs), and are produced by oligomerization of alpha, olefins, such as 1-decene. Group V base stocks include ail base stocks that do not belong to Groups I-IV, such as naphthenics, polyalkylene glycols (PAG), and esters.

TABLE 1

| API Classifi- | Group | Group | Group | Group | Group |
|---|---|---|---|---|---|
| cation | I | II | III | IV | V |
| % Saturates | <90 | ≥90 | ≥90 | Polyalpha- | All others |
| % S | >0.03 | ≤0.03 | ≤0.03 | olefins | not belonging |
| Viscosity | 80-120 | 80-120 | ≥120 | (PAOs) | to Groups I-IV |
| Index (VI) | | | | | |

In some embodiments, synthetic oils include polymers and oligomers of butenes including isobutene, 1-butene, 2-butene, butadiene, and mixtures thereof. In some embodiments, these oligomers can be characterized by a number average molecular weight (Mn) of from about 300 g/mol to about 9,000 g/mol, and in other embodiments from about 700 g/mol to about 1,300 g/mol. In some embodiments, these oligomers include isobutenyl mer units. Exemplary synthetic oils include polyisobutylene, poly(isobutylene-co-butene), and mixtures thereof. In some embodiments, synthetic oils may include polylinear α-olefins, poly-branched α-olefins, hydrogenated polyalphaolefins, and mixtures thereof.

In some embodiments, the synthetic oils include synthetic polymers or copolymers having a viscosity of about 20 cp or more, such as about 100 cp or more, such as about 190 cp or more, where the viscosity is measured by a Brookfield viscometer according to ASTM D-4402 at 38° C. In these or other embodiments, the viscosity of these oils can be about 4,000 cp or less, such as about 1,000 cp or less.

Useful synthetic oils can be commercially obtained under the tradenames Polybutene™ (Soltex; Houston, Tex.), and Indopol™ (Ineos). White synthetic oil is available under the tradename SPECTRASYN™ (ExxonMobil), formerly SHF Fluids (Mobil), Elevast™ (ExxonMobil), and white oil produced from gas to liquid technology such as Risella™ X 415/420/430 (Shell) or Primol™ (ExxonMobil) series of white oils, e.g. Primol™352, Primol™ 382, Primol™ 542, or Marcol™ 82, Marcol™ 52, Drakeol™ (Pencero) series of white oils, e.g. Drakeol™ 34 or a combination thereof. Oils described in U.S. Pat. No. 5,936,028 may also be employed.

In some embodiments, the addition of certain low to medium molecular weight (<10,000 g/mol) organic esters and alkyl ether esters to the present TPV compositions dramatically lower the Tg of the polyolefin and rubber components and of the overall composition. The addition of certain low to medium molecular weight (<10,000 g/mol) organic esters and alkyl ether esters improve the low temperature properties, particularly flexibility and strength. It was surprisingly observed that, such formulations have enhanced permeability and abrasion resistance. It is believed that these effects are achieved by the partitioning of the ester into both the polyolefin and rubber components of the compositions. Particularly suitable esters include monomeric and oligomeric aliphatic esters having a low molecular weight, such as an average molecular weight in a range from about 2000 or below, such as about 600 or below. In certain aspects, the ester is selected to be compatible, or miscible, with both the polyolefin and rubber components of the compositions, e.g., that the ester mixes with the other components to form a single phase. The esters found to be suitable include monomeric alkyl monoesters, monomeric alkyl diesters, oligomeric alkyl monoesters, oligomeric alkyl diesters, monomeric alkylether monoesters, monomeric alkylether diesters, oligomeric alkylether monoesters, oligomeric alkylether diesters, and mixtures thereof. Polymeric aliphatic esters and aromatic esters were found to be significantly less effective, and phosphate esters were for the most part ineffective.

Examples of esters which have been found satisfactory for use in the present TPY compositions include diisooctyldodecanedioate, dioctyl sebacate, butoxyethyloleate, n-butyloleate, n-butyltallate, isooctyloleate, isooctyltallate, dialkylazelate, diethylhexylsebacate, alkylalkylether diester glutarate, oligomers thereof, and mixtures thereof. Other analogues expected to be useful in the present TPY compositions include alkyl alkylether monoadipates and diadipates, monoalkyl and dialkyl adipates, glutarates, sebacates, azelates, ester derivatives of castor oil or tail oil, and oligomeric monoesters and diesters or monoalkyl and dialkyl ether esters therefrom. Isooctyltallate and n-butyltallate are useful. These esters may be used alone in the compositions, or as mixtures of different esters, or they may be used in combination with conventional hydro carbon oil diluents or processing oils, e.g., paraffin oil. In certain embodiments, the amount of ester plasticizer in the TPY composition is a range from about 0.1 wt % to about 40 wt % based upon a total weight of the TPV composition. In certain embodiments, the ester plasticizer is isooctyltallate. Such esters are available commercially as Plasthall™ available from Hallstar of Chicago, Ill. In certain embodiments, the ester plasticizer is n-butyl tallate.

### Preparation of TPV Compositions

In some embodiments, the rubber is cured or crosslinked by dynamic vulcanization. The term dynamic vulcanization refers to a vulcanization or curing process for a rubber contained in a blend with a thermoplastic resin, wherein the rubber is crosslinked or vulcanized under conditions of high shear at a temperature above the melting point of the thermoplastic polyolefin. The rubber can be cured by employing a variety of curatives. Exemplary curatives include phenolic resin cure systems, peroxide cure systems, and silicon-containing cure systems, such as hydrosilylation and silane grafting/moisture cure. Dynamic vulcanization can occur in the presence of the polyolefin, or the polyolefin can be added after dynamic vulcanization (e.g., post added), or both (e.g., some polyolefin can be added prior to dynamic vulcanization and some polyolefin can be added after dynamic vulcanization).

In some embodiments, the rubber can be simultaneously crosslinked and dispersed as fine particles within the thermoplastic matrix, although other morphologies may also exist. Dynamic vulcanization can be effected by mixing the thermoplastic elastomer components at elevated temperature in conventional mixing equipment such as roll mills, stabilizers, Banbury mixers, Brabender mixers, continuous mixers, mixing extruders and the like. Methods for preparing TPV compositions are described in U.S. Pat. Nos. 4,311,628, 4,594,390, 6,503,984, and 6,656,693, although methods employing low shear rates can also be used. Multiple-step processes can also be employed whereby ingredients, such as additional thermoplastic resin, can be added after dynamic vulcanization has been achieved as disclosed in International Application No. PCT/US04/30517.

In some embodiments, a process for the preparation of dynamically vulcanized thermoplastic vulcanizate includes melt processing raider shear conditions at least one thermoplastic resin, at least one rubber, at least one curing agent, and at least one polyhedral oligomeric silsesquioxane. In some embodiments, the melt processing may be performed under high shear conditions. Shear conditions are similar to conditions that exist when the TPY compositions are produced using common melt processing equipment such as Brabender or Banbury mixers (lab scale instruments) and commercial twin-screw extruders.

The word shear is added to indicate that the polyhedral oligomeric silsesquioxane is incorporated into TPV compositions by mixing under high shear temperature and intense mixing.

The skilled artisan will be able to readily determine a sufficient or effective amount of vulcanizing agent to be employed without undue calculation or experimentation.

As noted above, the TPV compositions are dynamically vulcanized by a variety of methods including employing a cure system, wherein the cure system includes a curative, such as a phenolic resin curative, a peroxide curative, a maleimide curative, a hexamethylene diamine carbamate curative, a silicon-based curative (including hydrosilylation curative, a silane-based curative such as a silane grafting followed by moisture cure), metal oxide-based curative (such as ZnO for butyl rubbers), sulfur-based curative, or a combination thereof.

Useful phenolic cure systems are disclosed in U.S. Pat. Nos. 2,972,600, 3,287,440, 5,952,425 and 6,437,030.

In some embodiments, phenolic resin curatives include resole resins, which can be made by the condensation of alkyl substituted phenols or unsubstituted phenols with aldehydes, such as formaldehydes, in an alkaline medium or by condensation of bi-functional phenoldialcohols. The alkyl substituents of the alkyl substituted phenols may have from about 1 to about 10 carbon atoms, such as dimethylolphenols or phenolic resins, substituted in para-positions with alkyl groups having from about 1 to about 10 carbon atoms. In some embodiments, a blend of octylphenol-formaldehyde and nonylphenol-formaldehyde resins are employed. The blend includes from about 25 wt % to about 40 wt % octylphenol-formaldehyde and from about 75 wt % to about 60 wt % nonylphenol-formaldehyde, such as from about 30 wt % to about 35 wt % octylphenol-formaldehyde and from about 70 wt % to about 65 wt % nonylphenol-formaldehyde. In some embodiments, the blend includes about 33 wt % octylphenol-formaldehyde and about 67 wt % nonylphenol-formaldehyde resin, where each of the octylphenol-formaldehyde and nonylphenol-formaldehyde include methylol groups. This blend can be solubilized in paraffinic oil at about 30% solids without phase separation.

Useful phenolic resins may be obtained under the tradenames SP-1044, SP-1045 (Schenectady International; Schenectady, N.Y.), which may be referred to as alkylphenol-formaldehyde resins.

An example of a phenolic resin curative includes that defined according to the general formula

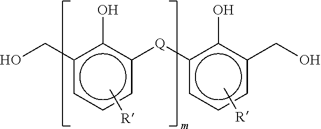

where Q is a divalent radical selected from the group consisting of —CH₂—˜, —CH₂—O—CH₂˜; m is zero or a positive integer from 1 to 20 and R′ is an organic group. In some embodiments, Q is the divalent radical —CH₂—O—CH₂—, m is zero or a positive integer from 1 to 10, and R′ is an organic group having less than 20 carbon atoms. In other embodiments, m is zero or a positive integer from 1 to 10 and R′ is an organic radical having from 4 to 12 carbon atoms.

In some embodiments, the phenolic resin is used in combination with a halogen source, such as stannous chloride, and metal oxide or reducing compound such as zinc oxide.

In some embodiments, the phenolic resin may be employed in an amount from about 2 parts by weight to about 6 parts by weight, such as from about 3 parts by weight to about 5 parts by weight, such as from about 4 parts by weight to about 5 parts by weight per 100 parts by weight of rubber. A complementary amount of stannous chloride may include from about 0.5 parts by weight to about 2.0 parts by weight, such as from about 1.0 parts by weight to about 1.5 parts by weight, such as from about 1.2 parts by weight to about 1.3 parts by weight per 100 parts by weight of rubber. In conjunction therewith, from about 0.1 parts by weight to about 6.0 parts by weight, such as from about 1.0 parts by weight to about 5.0 parts by weight, such as from about 2.0 parts by weight to about 4.0 parts by weight of zinc oxide may be employed. In some embodiments, the olefinic rubber employed with the phenolic curatives includes diene units deriving from 5-ethylidene-2-norbornene.

In some embodiments, useful peroxide curatives include organic peroxides. Examples of organic peroxides include di-tert-butyl peroxide, dicumyl peroxide, t-butylcumyl peroxide, α,α-bis(tert-butylperoxy) diisopropyl benzene, 2,5-dimethyl-2,5-di(t-butylperoxy)hexane (DBPH), 1,1-di(tert-butylperoxy)-3,3,5-trimethyl cyclohexane, n-butyl-4-4-bis(tert-butylperoxy) valerate, benzoyl peroxide, lauroyl peroxide, dilauroyl peroxide, 2,5-dimethyl-2,5-di(tert-butylperoxy) hexyne-3, and mixtures thereof. Also, diaryl peroxides, ketone peroxides, peroxydicarbonates, peroxyesters, dialkyl peroxides, hydroperoxides, peroxyketals and mixtures thereof may be used. Useful peroxides and their methods of use in dynamic vulcanization of TPV compositions are disclosed in U.S. Pat. No. 5,656,693.

In some embodiments, the peroxide curatives are employed in conjunction with a coagent. Examples of coagents include triallylcyanurate, triallyl isocyanurate, triallyl phosphate, sulfur, N-phenyl bis-maleamide, zinc diacrylate, zinc dimethacrylate, divinyl benzene, 1,2-poly butadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, and oximes such as quinone dioxime. In order to maximize the efficiency of peroxide/coagent crosslinking the mixing and dynamic vulcanization may be carried out in a nitrogen atmosphere.

In some embodiments, silicon-containing cure systems may include silicon hydride compounds having at least two Si—H groups. Silicon hydride compounds that are useful in practicing the present disclosure include methylhydrogenpolysiloxanes, methylhydrogendimethylsiloxane copolymers, alkylmethyl-co-methylhydrogenpolysiloxanes, bis(dimethylsilyl)alkanes, bis(dimethylsilyl)benzene, and mixtures thereof.

Useful catalysts for hydrosilylation include transition metals of Group VIII. These metals include palladium, rhodium, and platinum, as well as complexes of these metals. Useful silicon-containing curatives and cure systems are disclosed in U.S. Pat. Nos. 5,936,028, 4,803,244, 5,672,660, and 7,951,871.

In some embodiments, the silane-containing compounds may be employed in an amount from about 0.5 parts by weight to about 5.0 parts by weight per 100 parts by weight of rubber (such as from about 1.0 parts by weight to about 4.0 parts by weight, such as from about 2.0 parts by weight to about 3.0 parts by weight). A complementary amount of catalyst may include from about 0.5 parts of metal to about 20.0 parts of metal per million parts by weight of the rubber (such as from about 1.0 parts of metal to about 5.0 parts of metal, such as from about 1.0 parts of metal to about 2.0 parts of metal). In some embodiments, the olefinic rubber employed with the hydrosilylation curatives includes diene units deriving from 5-vinyl-2-norbornene.

For example, a phenolic resin can be employed in an amount of about 2 parts by weight to about 10 parts by weight per 100 parts by weight rubber (such as from about 3.5 parts by weight to about 7.5 parts by weight, such as from about 5 parts by weight to about 6 parts by weight). In some embodiments, the phenolic resin can be employed in conjunction with stannous chloride and optionally zinc oxide. The stannous chloride can be employed in an amount from about 0.2 parts by weight to about 10 parts by weight per 100 parts by weight rubber (such as from about 0.3 parts by weight to about 5 parts by weight, such as from about 0.5 parts by weight to about 3 parts by weight). The zinc oxide can be employed in an amount from about 0.25 parts by weight to about 5 parts by weight per 100 parts by weight rubber (such as from about 0.5 parts by weight to about 3 parts by weight, such as from about 1 parts by weight to about 2 parts by weight).

Alternately, in some embodiments, a peroxide can be employed in an amount from about 1×10⁻⁵ moles to about 1×10⁻¹ moles, such as from about 1×10⁻⁴ moles to about 9×10⁻² moles, such as from about 1×10⁻² moles to about 4×10⁻² moles per 100 parts by weight rubber. The amount may also be expressed as a weight per 100 parts by weight rubber. This amount, however, may vary depending on the curative employed. For example, where 4,4-bis(tert-butyl peroxy) diisopropyl benzene is employed, the amount employed may include from about 0.5 parts by weight to about 12 parts by weight, such as from about 1 parts by weight to about 6 parts by weight per 100 parts by weight rubber. The skilled artisan will be able to readily determine a sufficient or effective amount of coagent that can be used with the peroxide without undue calculation or experimentation. In some embodiments, the amount of coagent employed is similar in terms of moles to the number of moles of curative employed. The amount of coagent may also be expressed as weight per 100 parts by weight rubber. For example, where the triallylcyanurate coagent is employed, the amount employed can include front about 0.25 phr to about 20 phr, such as from about 0.5 phr to about 10 phr, based on 100 parts by weight rubber.

### Slip Agent

In certain embodiments, in addition to the rubber, thermoplastic resins, processing oils, and fillers, the present TPV compositions may optionally include a slip agent when the crosslinked rubber is cured with a phenolic or peroxide based cure systems. Slip agents can be defined as class of fillers or additives intended to reduce the coefficient of friction of the TPV composition while also improving the abrasion resistance. Examples of slip agents include siloxane based additives (such as polysiloxanes), ultra-high molecular weight polyethylene, a blend of siloxane based additives (such as polysiloxanes) and ultra-high molecular weight polyethylene, molybdenum disulfide molybdenum disulfide, halogenated and unhalogenated compounds based on aliphatic fatly chains, fluorinated polymers, perfluorinated polymers, graphite, and a combination thereof. The slip agents are selected with a molecular weight suitable for the use in oil, paste, or powder form.

Slip agents useful in the TPV compositions include, but ARE not limited to, fluorinated or perfluorinated polymers, such as Kynar™ (available from Arkema of King of Prussia, Pa.), Dynamar™ (available from 3M of Saint Paul, Minn.), molybdenum disulfide, or compounds based on aliphatic fatty chains, whether halogenated or not, or polysiloxanes. In some embodiments, the slip agents can be of the migratory type or non-migratory type.

In some embodiments, the polysiloxane comprises a migratory siloxane polymer which is a liquid at standard conditions of pressure and temperature. A suitable polysiloxane is a high molecular weight, essentially linear polydimethyl-siloxane (PDMS). Additionally, the polysiloxane may have a viscosity at room temperature in a range from about 100 to about 100,000 cSt, such as from about 1,000 to about 10,000 cSt, or from about 5,000 cSt to about 10,000 cSt.

In certain embodiments polysiloxane also contains R groups that are selected based on the cure mechanism desired for the composition containing the first polysiloxane. Typically, the cure mechanism is either by means of condensation cure or addition cure, but is generally via an addition cure process. For condensation reactions, two or more R groups per molecule should be hydroxyl or hydrolysable groups such as alkoxy group having up to about 3 carbon atoms. For addition reactions, and in some embodiments two or more R groups per molecule may be unsaturated organic groups, typically alkenyl or alkynyl groups, such as up to about 8 carbon atoms. One suitable commercially available material useful as the first polysiloxane is XIAMETER™ PMX-200 Silicone Fluid available from Dow Corning Midland, Mich. In certain embodiments, the TPV compositions described herein contain polysiloxane in a range from about 0.2 wt % to about 20 wt %, such as from about 0.5 wt % to about 15 wt % or from about 0.5 wt % to about 10 wt %.

In certain embodiments, polysiloxane, such as polyorganosiloxanes, comprises a non-migratory polysiloxane which is bonded to a thermoplastic material. The polysiloxane is reactively dispersed in a thermoplastic material, which may be any homopolymer or copolymer of ethylene and/or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. In one embodiment, the thermoplastic material is a polypropylene homopolymer. Suitable methods of reactively bonding a polysiloxane to an organic thermoplastic polymer, such as a polyolefin, are disclosed in International Patent Publication Nos. WO2015/132190 and WO2015/150218, the entire contents of which are incorporated herein by reference for U.S. patent practice.

In some embodiments, the polysiloxane may comprise predominantly D and/or T units and contains some alkenyl functionalities, which assist in the reaction with the polymer matrix. There is a covalent bond between the polysiloxane and the polypropylene. In some embodiments, the reaction product of polysiloxane and the polypropylene has a number average molecular weight in a range from about 0.2 kg/mol to about 100 kg g/mole. The number average molecular weight of the reaction product of the polyorganosiloxane and the polymer matrix is at least 1.1 times, such as at least 1.3 times, the number average molecular weight of the base polyorganosiloxane. In some embodiments, the second polyorganosiloxane has a gum loading of in a range from about 20 wt % and about 50 wt %.

One example of a slip agent is HMB-0221. HMB-0221 is provided as pelletized concentrate containing reaction products of ultrahigh molecular weight siloxane polymer reactively dispersed in polypropylene homopolymer. HMB-0221 is available from Dow Corning of Midland, Mich. In certain embodiments, the TPV compositions described herein contain a non-migratory polysiloxane in a range from about 0.2 wt % to about 20 wt %, such as from about 0.2 wt % to about 15 wt % or from about 0.2 wt % to about 10 wt %.

### Properties of the TPV Compositions

In some embodiments, the TPY compositions useful as polymeric outer sheaths in flexible pipes include one or more of the following properties.

In some embodiments, the TPV compositions exhibit a carbon dioxide (CO₂) permeability (at 60° C.) of about 30 barrers or more, such as about 40 barrers or more, such as about 50 barrers or more.

In some embodiments, the TPV compositions exhibit an abrasion loss of after 1000 cycles of 120 mg or less, such as about 90 mg or less, such as about 70 mg or less.

In some embodiments, the TPV compositions exhibit a tensile strength at yield of about 7 MPa, such as about 8 MPa, such as about 9 MPa, such as about 10 MPa.

In some embodiments, the TPV compositions exhibit a Young's modulus of about 200 MPa, such as about 250 MPa, such as about 300 MPa.

In some embodiments, the TPV compositions exhibit a tensile strain at yield of about 7% or more, such as about 9% or more, such as about 11% or more, such as about 13% or more.

In some embodiments, the TPV compositions exhibit a thermal conductivity of about 0.30 W/m·K or less, such as about 0.25 W/m·K or less, such as about 0.20 W/m·K or less.

In some embodiments, the TPV compositions exhibit a coefficient of friction (static) of about 0.8 or less, such as about 0.7 or less, such as about 0.65 or less.

In some embodiments, the TPV compositions exhibit a coefficient of friction (dynamic) of from about 0.8 or less, such as about 0.7 or less, such as about 0.65 or less.

Abrasion loss was measured according to ASTM D4060-14 in which the method was performed on both sides of a 4″ circular specimen cut from compression molded plaques. Wheel H-22 was used with 1 kg weight and 1000 revolutions. The wheel was resurfaced before testing each specimen (or after every 1000 cycles).

Thermal conductivity was measured according to ASTM C518-17 in which the method was performed on TA FOX50-190 instrument. Compression molded plastics plaques were die cut into disc specimens of two inch diameter. The specimens were measured at 25° C. Each material was measured in duplicate.

Young's Modulus, tensile strength at yield, and tensile strain at yield were measured according to ISO 37. The samples were tested using crosshead speed of 2 in/min at 23° C. on a compression molded plastic plaque.

In some embodiments, the TPY composition has a hardness that is from about 70 Shore A to about 60 Shore D, such as from about 40 Shore A to about 80 Shore A, such as from about 50 Shore A to about 70 Shore A, such as from about 55 Shore A to about 70 Shore A. Shore A Hardness was measured using a Zwick automated durometer according to ASTM D2240 (15 sec. delay). Shore D Hardness was measured using a Zwick automated durometer according to ASTM D2240.

CO₂ Gas permeability was measured according to ISO 2782-1: 2012(E) in which the thickness of each sample was measured at 5 points homogeneously distributed over the sample permeation area. The compression molded test specimen was bonded onto the holders with suitable adhesive cured at the test temperature. The chamber was evacuated by pulling vacuum on both sides of the film. The high pressure side of the film was exposed to the test pressure with CO₂ gas at 60° C. The test pressure and temperature was maintained for the length of the test, recording temperature and pressure at regular intervals. The sample was left under pressure until steady state permeation has been achieved (3-5 tunes the time lag (τ)).

### Experimental

Table 2 sets forth the ingredients and amounts (parts per hundred rubber, phr) employed in each sample and the results of physical testing—CO₂ permeability, abrasion loss, and other mechanical and physical properties of the inventive and comparative examples are provided in Table 2 that were performed on each sample. Those samples that correspond with the present disclosure are designated with “Ex.,” and those that are comparative are designated with the letter “C.” Comparative 1 (C1), Example 1 (Ex1), and Example 2 (Ex2) are TPV compositions that include a 75 phr oil extended EPDM (Vistalon™ 3666). Comparative 2 (C2), Comparative 3 (C3), Example 3 (Ex3), Example 4 (Ex4), Example 5 (Ex5), and Example 6 (Ex6) are TPY compositions that include a non-oil extended EPDM (Vistalon™ 9600), All Comparative and Example Samples, except for C3, Ex5, and Ex6 include a siloxane slip agent (DOW-Corning™ HMB-0221 Masterbatch). Preparation of the examples and comparatives is as follows.

### Sample Preparation Using a Brabender Mixer

Thermoplastic vulcanizate preparation was earned out under nitrogen in a laboratory Brabender-Plasticorder (model EPL-V5502). The mixing bowls had a capacity of 85 ml with the cam-type rotors employed. The plastic was initially added to the mixing bowl that was heated to 180° C. and at 100 rpm rotor speed. After plastic melting (2 minutes), the rubber, inorganic additives, and processing oil were packed into the mixer. After homogenization of the molten polymer blend (in 3-4 minute a steady torque was obtained), the curative was added to the mix, which caused a rise in the motor torque.

Mixing was continued for about 4 more minutes, after which the molten TPV was removed from the mixer, and pressed when hot between Teflon plates into a sheet which was cooled, cut-up, and compression molded at about 400° F. A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (140° F.). Dog-bones were cut out of the molded (aged at room temperature for 24 hours) plaque for tensile testing (0.16″ width, 1.1″ test length (not including tabs at end)).

SnCl₂ (MB) is an anhydrous stannous chloride polypropylene masterbatch. The SnCl₂ MB contains 45 wt % stannous chloride and 55 wt % of polypropylene having an MFR of 0.8 g/10 min (ASTM D1238; 230° C. and 2.16 kg weight).

Zinc oxide (ZnO) is Kadox 911.

The phenolic curative (a phenolic resin in oil, 30 wt % phenolic resin and 70 wt % oil) is a resole-type resin obtained from Schenectady International.

The filler is Icecap™ K Clay (available from Burgess).

The elastomeric (rubber) terpolymer is an EPDM (Vistaion 3666™ or Vistalon 9600™), and the molecular properties of each EPDM is provided above. The polypropylene is a polypropylene homopolymer obtained under the trade name PP5341™ (ExxonMobil).

The oil for samples C1, C2, Ex1, and Ex2 is a paraffinic oil obtained under the trade name Paramount 6001R™ (Chevron Phillips), while the oil for samples C3, Ex5, and Ex6 is an ester plasticizer available under the trade name Plasthall™ 100 (Hallstar).

Abrasion loss was measured according to ASTM D4060-14 in which the method was performed on both sides of a 4″ circular specimen cut from compression molded plaques. Wheel H-22 was used with 1 kg weight and 1000 revolutions. The wheel was resurfaced before testing each specimen (or after every 1000 cycles).

Thermal conductivity was measured according to ASTM C518-17 in which the method was performed on TA FOX50-190 instrument. Compression molded plastics plaques were die cut into disc specimens of two inch diameter. The specimens were measured at 25° C. Each material was measured in duplicate.

Young's Modulus, tensile strength at yield, and tensile strain at yield were measured according to ISO 37. The samples were tested using crosshead speed of 2 in/min at 23° C.

CO₂ Gas permeability was measured according to ISO 2782-1: 2012(E) in winch the thickness of each sample was measured at 5 points homogeneously distributed over the sample permeation area. The compression molded test specimen was bonded onto the holders with suitable adhesive cured at the test temperature. Tire chamber was evacuated by pulling vacuum on both sides of the film. The high pressure side of the film was exposed to the test pressure with CO2 gas at 60° C. The test pressure and temperature was maintained for the length of the test, recording temperature and pressure at regular intervals. The sample was left under pressure until steady state permeation has been achieved (3-5 times the time lag (τ)).

Static and dynamic coefficient of friction was measured according to ISO 8295:1995 on compression molded plaques. The coefficient of friction against a glass sled was measured on an AFT170500D machine at a speed of 100 mm/min with a 15 sec dwell time.

TABLE 2
Formulation and Properties of the TPV Compositions (parts per hundred rubber^{‡})

| | C1 | Ex1 | Ex2 | C2 | Ex3 | Ex4 | C3 | Ex5 | Ex6 |
|---|---|---|---|---|---|---|---|---|---|
| Formulation | | | | | | | | | |
| EPDM (non-oil extended) | — | — | — | 100 | 100 | 100 | 100 | 100 | 100 |
| EPDM (75 phr oil extended) | 175 | 175 | 175 | — | — | — | — | — | — |
| Polypropylene homopolymer | 429 | 429 | 429 | 429 | 429 | 429 | 451 | 451 | 451 |
| Slip agent | 22 | 22 | 22 | 22 | 22 | 22 | — | — | — |
| Clay | 42 | 42 | 42 | 42 | 42 | 42 | 12 | 12 | 12 |
| ZnO | 2 | 2 | 2 | 2 | 2 | 2 | 2 | 2 | 2 |
| Oil | 49.99 | 49.99 | 49.99 | 49.99 | — | — | 124.99 | 124.99 | 124.99 |
| SnCl₂ (MB) | 1.67 | 1.67 | 1.67 | 1.67 | 1.67 | 1.67 | 1.67 | 1.67 | 1.67 |
| Phenolic resin in oil | 12.82 | 12.82 | 12.82 | 12.82 | 12.82 | 12.82 | 12.82 | 12.82 | 12.82 |
| Octamethyl POSS (MS0830) | — | 36.72 | — | — | 34.71 | — | — | 36.72 | — |
| Octaisobutyl POSS (MS0825) | — | — | 73.45 | — | — | 34.71 | — | — | 36.72 |
| Total phr of Oil | 124.99 | 124.99 | 124.99 | 49.99 | 49.99 | 49.99 | 124.99 | 124.99 | 124.99 |
| Total (phr) | 734.48 | 771.20 | 771.20 | 659.48 | 694.19 | 694.19 | 704.48 | 741.48 | 741.48 |
| Properties | | | | | | | | | |
| CO₂ Permeability @ 60° C. (barrers) | 98 | 126 | 115 | 46 | 61 | 87 | 96 | 113 | 114 |
| Abrasion loss (mg/1000 cycle) | 63 | 85 | 55 | 84 | 95 | 49 | — | — | — |
| Tensile strength @ yield (MPa) | 12 | 11.4 | 11.1 | 15.5 | 14.3 | 14.9 | 12.0 | 11.0 | 11.1 |
| Young's Modulus (MPa) | 434 | 455 | 421 | 692 | 707 | 653 | 378 | 402 | 369 |
| Tensile strain at yield (%) | 22 | 20.5 | 22.6 | 16.5 | 14.3 | 17.7 | 32.5 | 25.1 | 29.0 |
| Thermal conductivity (W/m · K) | 0.190 | 0.190 | 0.180 | 0.190 | 0.194 | 0.187 | — | — | — |
| Coefficient of friction (Static) | 0.635 | 0.433 | 0.553 | 0.739 | 0.652 | 0.531 | — | — | — |
| Coefficient of friction (Dynamic) | 0.649 | 0.447 | 0.559 | 0.611 | 0.575 | 0.476 | — | — | — |

^{‡}Parts per hundred robber (phr) is based on the rubber phase. The TPV formulations assume that rubber is 100 phr (parts per hundred dry rubber, e.g., rubber without the oil extension. Formulations C1, Ex1, and Ex2 have 175 for rubber as those formulations contain 75 phr of extender oil.

The POSS examined include octamethyl POSS [(CH₃SiO_{1.5})₈], and octaisobutyl POSS [((CH₃)₂CHCH₂SiO_{1.5})₈] (both available from Hybrid Plastics Inc.), and show excellent compatibility with polyolefins while increasing the overall free volume of the TPV matrix. The data in Table 2 show that the permeability is greatly enhanced at elevated temperatures without detriment to the mechanical properties when the TPV composition includes the polyhedral oligomeric silsesquioxanes. For example, the CO₂ permeability increases by greater than about 15% for the oil extended EPDM and increases by greater than about 30% for the non-oil extended EPDM. Tensile properties and thermal conductivity remained consistent across samples. In addition, the coefficient of friction was reduced by the inclusion of the POSS in the TPV compositions.

Surprisingly, unlike other plasticizers that enhance the free volume of the TPV compositions and reduce the tensile properties of the TPV compositions, it was unexpectedly observed that the octamethyl POSS and octaisobutyl POSS helped to enhance permeability while retaining tensile properties of the TPV compositions. In addition, the coefficient of friction was surprisingly reduced by the inclusion of the POSS in the TPV compositions which allows similar or improved overall abrasion resistance. Finally, it was surprisingly found that the POSS served as a processing aid when used as part of the TPV composition because typical inorganic nanofillers normally increase viscosity and reduce the extrudability of the material.

Thus, the TPV compositions exhibit excellent gas permeability and have excellent mechanical properties. The data reveal that, advantageously, the TPV compositions disclosed herein are useful materials for layers, e.g., outer sheaths and intermediate sheaths, in flexible pipes particularly when enhanced permeability is desired.

All documents described herein are incorporated by reference herein, including any priority documents and/or testing procedures to the extent they are not inconsistent with this text. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure. As is apparent from the foregoing general description and the specific embodiments, while forms of the embodiments have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, an element or a group of elements is preceded with the transitional phrase “comprising,” it is understood that we also contemplate the same composition or group of elements with transitional phrases “consisting essentially of,” “consisting of,” “selected from the group of consisting of,” or “1” preceding the recitation of the composition, element, or elements and vice versa, e.g., the terms “comprising,” “consisting essentially of,” “consisting of” also include the product of the combinations of elements listed after the term.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

The invention claimed is:

1. A thermoplastic vulcanizate (TPV) composition, comprising:
a rubber, a thermoplastic polyolefin, and a polyhedral oligomeric silsesquioxane, wherein:
a concentration of the rubber is from 10 wt % to 80 wt % based on a combined weight of the rubber and the thermoplastic polyolefin;
a concentration of the thermoplastic polyolefin is from 20 wt % to 90 wt % based on the combined weight of the rubber and the thermoplastic polyolefin; and
a concentration of the polyhedral oligomeric silsesquioxane is from 0.1 wt % to 20 wt % based on the total weight of the TPV composition.

2. The TPV composition of claim 1, wherein the concentration of the rubber is from 10 wt % to 30 wt % based on the combined weight of the rubber and the thermoplastic polyolefin, and the concentration of the thermoplastic polyolefin is from 25 wt % to 75 wt % based on the combined weight of the rubber and the thermoplastic polyolefin.

3. The TPV composition of claim 1, wherein the polyhedral oligomeric silsesquioxane with general formula [RSiO_{1.5}]ₓ where x is from 4 to 15.

4. The TPV composition of claim 1, wherein the polyhedral oligomeric silsesquioxane has a general formula [RSiO_{1.5}]ₓ where R represents organic substituents selected from the group of H, siloxy, cyclic aliphatic, linear aliphatic, or aromatic groups.

5. The TPV composition of claim 4, wherein the polyhedral oligomeric silsesquioxane with general formula [RSiO_{1.5}]ₓ where R represents organic substituents selected from the group of cyclic aliphatic or linear aliphatic.

6. The TPV composition of claim 1, wherein the polyhedral oligomeric silsesquioxane is octamethyl POSS ([(CH₃SiO_{1.5})₈]).

7. The TPV composition of claim 1, wherein the polyhedral oligomeric silsesquioxane is octaisobutyl POSS ([((CH₃)₂CHCH₂SiO_{1.5})₈]).

8. The TPV composition of claim 1, further comprising a plasticizer.

9. The TPV composition of claim 8, wherein the plasticizer is selected from the group consisting of mineral oil, paraffinic oil, polyisobutylene, synthetic oil, triisononyl trimellitate, low molecular weight alkyl ester, and a combination thereof.

10. The TPV composition of claim 1, wherein the TPV composition further comprises at least one of a filler, a slip agent, or a nucleating agent.

11. The TPV composition of claim 10, wherein the filler comprises calcium carbonate, clay, silica, talc, titanium dioxide, carbon black, mica, wood flour, or a combination thereof.

12. The TPV composition of claim 1, further comprising a cure system.

13. The TPV composition of claim 12, wherein the cure system comprises a phenolic resin, a peroxide, a maleimide, a hexamethylene diamine carbamate, a silicon-based curative, a silane-based curative, metal oxide, a sulfur-based curative, or a combination thereof.

14. The TPV composition of claim 12, wherein the cure system comprises at least one of a hydrosilylation curative and a phenolic resin curative.

15. The TPV composition of claim 1, wherein the rubber is an ethylene propylene rubber, a nitrile rubber, a butyl rubber, a halobutyl rubber, or a combination thereof.

16. The TPV composition of claim 1, wherein the ethylene propylene rubber is an ethylene propylene diene monomer rubber.

17. The TPV composition of claim 16, wherein the ethylene propylene diene monomer rubber comprises a diene component that includes ethylidene norbornene, vinyl norbornene, or a combination thereof.

18. The TPV composition of claim 15, wherein the butyl rubber is selected from the group consisting of isobutylene-isoprene rubber (IIR), brominated isobutylene-isoprene rubber (BIIR), chlorinated isobutylene-isoprene rubber (CIIR), and isobutylene paramethyl styrene rubber (BIMSM).

19. The TPV composition of claim 15, wherein the butyl rubber is an isobutylene-paramethylstyrene rubber comprising from 0.5 wt % to 25 wt % paramethylstyrene based on an entire weight of the rubber.

20. The TPV composition of claim 15, wherein the butyl rubber is an isobutylene-isoprene rubber comprising from 0.5 wt % to 30 wt % isoprene based on an entire weight of the rubber.

21. The TPV composition of claim 15, wherein the butyl rubber is a brominated isobutylene-isoprene rubber, a chlorinated isobutylene-isoprene rubber, or a combination thereof comprising a percent by weight halogenation of from 0.3 wt % to 7 wt % based on an entire weight of the rubber.

22. The TPV composition of claim 1, wherein the rubber is a nitrile rubber comprising 1,3-butadiene or isoprene and acrylonitrile.

23. The TPV composition of claim 15, wherein the nitrile rubber has an acrylonitrile-derived content that is from 20 wt % to 50 wt % based on a total weight of a nitrile based rubber.

24. The TPV composition of claim 1, wherein the TPV composition has a CO₂ permeability at 60° C. of more than 40 barrers as measured according to ISO 2782-1.

25. The TPV composition of claim 1, wherein the TPV composition has an abrasion loss of 120 mg/1000 cycle or less as measured according to ASTM D4060.

26. The TPV composition of claim 1, wherein the TPV composition has a tensile strength at yield of 9 MPa or more at 23° C. as measured according to ISO 37 on a compression molded plaque.

27. The TPV composition of claim 1, wherein the TPV composition has a tensile strain at yield of 7% or more at 23° C. as measured according to ISO 37 on a compression molded plaque.

28. The TPV composition of claim 1, wherein the TPV composition has a thermal conductivity of 0.25 W/m·K or less as measured according to ASTM C518-17.

29. The TPV composition of claim 1, wherein the thermoplastic polyolefin is one or more of a polypropylene, a polyethylene, a polybutene-1, or a combination thereof.

30. The TPV composition of claim 1, wherein the TPV composition has a hardness of from 70 Shore A to 60 Shore D, wherein Shore A hardness and Shore D harness is measured using a Zwick automated durometer according to ASTM D2240.

31-44. (canceled)
